(19) United States
(12) Patent Application Publication
(10) Pub. No.: US 2021/0111870 A1
(43) Pub. Date: Apr. 15, 2021

(54) AUTHORIZING AND VALIDATING REMOVABLE STORAGE FOR USE WITH CRITICAL INFRASTRCTURE COMPUTING SYSTEMS

(71) Applicants: Florida Power & Light Company, Juno Beach, FL (US); Inventus Holdings, LLC, Juno Beach, FL (US)

(72) Inventors: Ryan V. Cooper, Stuart, FL (US); Jay K. Limbasiya, West Palm Beach, FL (US); Michael T. Rothenberg, Stuart, FL (US)

(21) Appl. No.: 16/601,088

(22) Filed: Oct. 14, 2019

(51) Int. Cl. H04L 9/06; H04L 9/32; H04L 9/30

(52) U.S. Cl. CPC H04L 9/0643; H04L 9/3234; H04L 2209/38; H04L 9/30; H04L 9/3236

(57) ABSTRACT

An information processing system validates authorization of a removable storage device for accessing the system. For example, the system detects a removable storage device. A first content hash and a first set of device verification data are obtained from a validation token stored on the storage device. A second content hash is obtained based on hashing content currently stored on the storage device. A second set of device verification data is obtained from the storage device. The system denies the storage device access to the system based on at least one of the first and second content hashes failing to match and the first and second sets of device verification data failing to match. The system grants the storage device access to the system based on the first and second content hashes matching and the first and second sets of device verification data matching.

### FIELD OF THE DISCLOSURE

The present invention generally relates to computing network and system security, and more particularly to authorizing and validating removable storage devices for use with computing systems.

### BACKGROUND

The North American power grid has been characterized by the Smithsonian Institution as the largest machine ever built by mankind. The size, geographic diversity, environmental diversity, and the multitude of components that comprise the power grid presents unique challenges in the rapid and efficient upgrading the system with diverse new technologies that realize America's objective of improved power grid reliability and hardening. Accordingly, utility systems are an integral part of modern day life. Unfortunately, this makes the power grid and other critical national infrastructure systems a desirable target for malicious activities such as cyber-attacks, data breaches, and other types of activities. One mechanism for safeguarding components of these and other types of systems is through the use of air-gapped networks. An air-gapped network generally isolates its components from unsecured networks and, in some instances, any outside network. Although air-gapped networks have their advantages, they generally fail to provide safeguards against physical access to the network components. For example, effective safeguards against unauthorized use of removable storage devices within air-gapped networks currently do not exist.

### BRIEF DESCRIPTION OF THE SEVERAL VIEWS OF THE DRAWINGS

The accompanying figures where like reference numerals refer to identical or functionally similar elements throughout the separate views, and which together with the detailed description below are incorporated in and form part of the specification, serve to further illustrate various embodiments and to explain various principles and advantages all in accordance with the present disclosure, in which:

FIG. 1 is an illustrative example of a system for authorizing and validating removable storage devices for use with one or more computing systems according to one embodiment of the present invention;

FIG. 2 is an illustrative example of a power generation and distribution system according to one embodiment of the present invention;

FIG. 3 is an operational flow diagram illustrating one example of an authorization process for authorizing a removable storage device for use with one or more computing systems according to one embodiment of the present invention;

FIGS. 4-5 are operational flow diagrams illustrating one example of a validation process performed by a computing system for validating a removable storage device as an authorized device for use with the computing system according to one embodiment of the present invention;

FIG. 6 is an illustrative example showing the various types of data generated for and stored on a removable storage device as part of the authorization process of FIG. 3 according to one embodiment of the present invention;

FIG. 7 is an illustrative example showing the various types of data generated for and stored on a removable storage device as the validation process of FIGS. 4-5 according to one embodiment of the present invention; and

FIG. 8 is a block diagram illustrating another example of an information processing system according to one embodiment of the present invention.

### DETAILED DESCRIPTION

As required, detailed embodiments are disclosed herein; however, it is to be understood that the disclosed embodiments are merely examples and that the systems and methods described below can be embodied in various forms. Therefore, specific structural and functional details disclosed herein are not to be interpreted as limiting, but merely as a basis for the claims and as a representative basis for teaching one skilled in the art to variously employ the disclosed subject matter in virtually any appropriately detailed structure and function. Further, the terms and phrases used herein are not intended to be limiting, but rather, to provide an understandable description.

The terms “a” or “an”, as used herein, are defined as one or more than one. The term plurality, as used herein, is defined as two or more than two. The term another, as used herein, is defined as at least a second or more. The terms “including” and “having”, as used herein, are defined as comprising (i.e., open language). The term “coupled”, as used herein, is defined as “connected”, although not necessarily directly, and not necessarily mechanically. The term “configured to” describes hardware, software or a combination of hardware and software that is adapted to, set up, arranged, built, composed, constructed, designed or that has any combination of these characteristics to carry out a given function. The term “adapted to” describes hardware, software or a combination of hardware and software that is capable of, able to accommodate, to make, or that is suitable to carry out a given function.

The below described systems and methods provide for authorizing and validating removable storage devices for use with computing systems. In air-gapped networks or standalone information technology systems, which are networks/systems that are not connected to an outside network, a quick and efficient mechanism for authorizing removable storage devices is not readily available. In particular, traditional removable storage blocking solutions generally require an endpoint agent and central management console. Another problem is that these solutions usually rely on the removable storage device information to be inputted into the outside management console and do not provide a timeout or validation that additional files have not been added to the removable storage device afterwards.

Traditional systems also do not have the ability to inventory what systems the removable storage device has been connected to. For example, a vendor has his/her removable storage device authorized for use in an air-gapped network but copies files to the device after authorization. These files could contain malicious code. In another example, the vendor plugs his/her removable storage device into multiple air gap/stand-alone systems within a critical network. A record of this connection is generally not stored in a central location that is easy to audit. In yet another example, the vendor has a removable storage device that is authorized for use within an air-gapped system but the administrators forget to remove the authorization. This allows the vendor to travel to another location where the removable storage device gets infected. If the vendor comes back to air-gapped network the removable storage device can infect the air-gapped system. In addition, the vendor may conduct an unauthorized copy of confidential data from the air-gapped system. Traditional methods generally do not allow for the auditing of systems for which the vendor has connected removable storage to or files for which the vendor has copied between the system and removable storage.

Embodiments of the present invention overcome the above problems by binding a validation/security token to the removable storage device and utilizing a software/hardware component within a standalone computing system or at the endpoints within air-gapped networks to which the removable storage device will connect. Embodiments also enable auditing of removable storage device activity by stamping the tokens with the systems that the removable storage device has been connected to and the files copied to or from the removable storage. For example, the removable storage device may be required to first connect to a validation device. The validation device inventories and hashes files on the removable storage device. The hash calculations and the local system time may then be stored on the removable storage device in a file. The file is then encrypted and salted with the removable storage device's identification information (e.g., make, model, serial) to form a token.

Once the removable storage device has been validated, it may connect to an endpoint within an air-gapped network, a standalone system, or any other type of computing system. Once the removable storage device connects to an endpoint, an authentication agent (software/hardware module) on the endpoint reverses the token process. For example, module decrypts the validation token stored on the removable storage device and leverages the salt (e.g., make, model, serial) to ensure that the removable storage device identified as being authorized/validated by the token is the same device that is being plugged into the endpoint. This ensures the user did not copy the token and files to another storage device.

The files on the removable storage device may then be hashed again and compared against the hash stored in the token to ensure no additional files have been added or existing files have been changed. Access data such as a time stamp in the token may then be compared with the local system time of the endpoint and the “acceptable access time” set on the authentication agent to ensure the storage device was connected within the acceptable time. Once authentication/validation is complete the removable storage device is allowed to mount to the file system of the endpoint and the user can access the contents of the removable storage device. If the removable device is not authorized, then the authentication agent does not allow the removable storage device to mount to the file system.

The authentication endpoint at the endpoint can also store a second token on the removable storage device that includes, for example, identification information for the endpoint that the USB storage device was connected to. This can be used for a check out process to track all systems the removable storage device was connected to and if new files have been added to the removable storage device and taken out of the protected area. Each machine for which the removable storage device is connected is able to place a token on the removable storage device. These tokens can be appended into a local blockchain to create an immutable and auditable history of where the device has been. This blockchain can then be reviewed on facility exit for security deviations. The blockchain can also serve as an audit trail to changes made on the removable storage device.

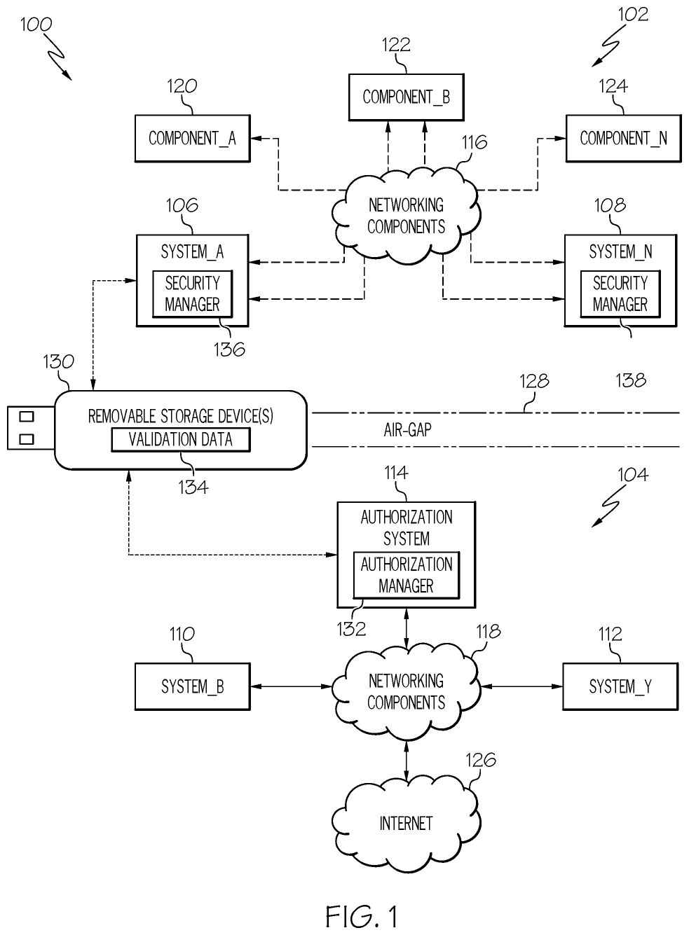

FIG. 1 shows one example of an operating environment 100 for validating and authorizing removable storage devices for use with computing systems. In one embodiment, the operating environment 100 comprises a plurality of networks 102, 104 each comprising various systems and components. In one embodiment, a network refers to a group or collection of information processing systems, computing hardware, sensors and/or the like that are communicatively coupled together through one or more communication mechanisms.

In the example, shown in FIG. 1, each of the networks 102, 104 comprises one or more information processing systems 106 to 114; networking components 116, 118; system components 120 to 124; and/or the like. The information processing systems 106 to 114 may be any type of computing system such as a desktop, notebook, server, workstation, remote terminal, mainframe, embedded device, tablet, wearable computing devices, wireless communication devices, and/or the like. The networking components 116, 118 comprise devices such as routers, switches, modems, firewalls, gateways, and/or the like. System components 120 to 124, in one embodiment, may include sensors, machines, databases, storage devices, software, hardware, and/or the like. It should be noted that the networks 102, 104 are not limited to the features shown in FIG. 1 and other features/components may be included in or removed from the networks 102, 104 as well.

In one example, the plurality of networks 102, 104 may be part of a power generation and distribution system or other Critical Infrastructure system such as water treatment facilities, transport networks, hospitals, and/or the like where certain components of these systems require a higher level of security than other components. In another example, the plurality of networks 102, 104 may be part of a government network, a confidential and sensitive data network, a military network, a financial services network, a nuclear power plant network, an industrial manufacturing network, and/or any other type of network where access to network components and/or data requires a high-level of security.

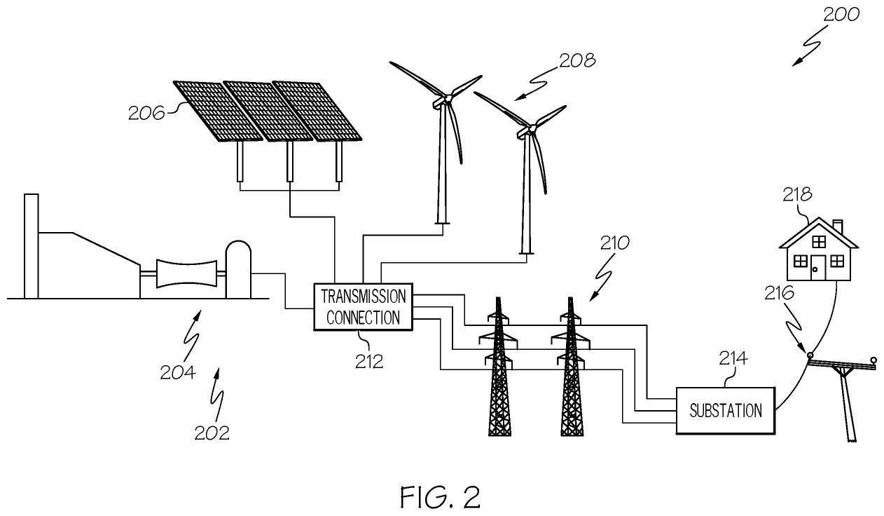

One example of a power generation and distribution system 200 is shown in FIG. 2. In this example, the power generation and distribution system 200 is used to provide electrical power to consumer premises 218. The example shown in FIG. 2 depicts a number of example power generation components 202 for a utility system. Illustrated are a combined cycle gas generator 204, a solar array farm 206, and a wind farm 208. In further examples, operational contexts are able to include one power generation component, multiple collocated power generation components, power generation components that are physically separated and supply a common electrical power transmission or distribution system, any one or more power generation components, or combinations of these. These power generation components are able to be of any suitable type or design.

Electrical power generated by one or more power generation components may be provided to a power transmission system 210. The illustrated example depicts a transmission connection 212 that couples one or more sources within power generation components 202 to the power transmission system 210. The transmission connection 212 and power transmission system 210 AOIs in an example include suitable step-up transformers and long-distance transmission lines to convey the generated electrical power to remote power distribution networks, other electrical power consumers, or both.

The illustrated power transmission system 210 provides electrical power to one or more distribution systems including a substation 214, distribution lines 216, and premises 218. The substation 214 AOI may include transformers, protection devices, and other components to provide electrical power to power distribution lines 216. The power distribution lines 216 deliver power produced by the generating components 202 to customer premises, such as the illustrated home 218. In general customer premises are coupled to the power distribution system 210 and are able to include any combination of residential, commercial, or industrial buildings.

Continuing with the above example, the first network 102 of FIG. 1 may be a control system network within one or more of the power generation components 202 of the utility system and the second network 104 may be a corporate enterprise network for the utility system. The systems 106, 108 of the first network 102 may be industrial control (IC) systems such as supervisory control and data acquisition (SCADA) systems, and the system components 120 to 124 may be sensors such as flow rate sensors, water level sensors, temperature sensors, radioactivity level sensors, fan/pump speed sensors, and/or the like.

IC and SCADA systems work together for monitoring and controlling operations/processes corresponding to the management of facilities and their machinery/equipment. For example, IC systems may control and monitor machinery and their physical processes while SCADA systems help facilitate control of the facilities, machinery, and equipment. Examples of IC systems include computing systems (e.g., desktops, notebooks, servers, etc.), databases, and/or the like. Examples of SCADA systems include programmable logic controllers (PLCs), remote terminal units (RTUs), human machine interfaces (HMIs), workstations, servers, and/or the like. These systems 106, 108 and components 120 to 124 may communicate directly with each other via direct interface coupling and/or may utilize one or more networking components 116.

IC and SCADA systems are critical for the operation and safety of the power generation components 202. Therefore, the first network 102 may be a more desirable target for cyber-attacks, hacking, and other malicious activity than other networks such as the second network 104 and require a higher degree of security than the second network 104. One mechanism for providing increased levels of network security is the utilization of air-gapped networks. An air-gapped network is a network that is physically or logically isolated from unsecured networks such as the Internet, unsecured local networks and/or the like.

For example, FIG. 1 shows the first network 102 as being physically and/or logically isolated from the second network 104 and the Internet 126. In other words, communication between the first network 102 and the second network 104 and between the first network 102 and the Internet 126 is not physically or logically possible in the example shown in FIG. 1. This isolation is represented as an “air-gap” 128. The air-gap 128 may be physically created by removing network interface cards; ensuring none of the systems, devices, and components of the network 102 are coupled to another system, device, or component having access to an outside network; and/or the like. The air-gap 128 may be logically created by utilizing networking components such as a firewall.

Although a network 102 may be air-gapped network security issues may still arise. For example, employees and contractors require the ability to interact with the systems 106, 108 and components 120, 124 of the air-gapped network 102 for maintenance, installing applications, moving data between systems, storing data, and/or the like. One mechanism for accomplishing these and other tasks is through the use of removable storage devices 130. A removable storage device 130, in one embodiment, is any storage device that is capable of being coupled to and removable from a computing system. In at least some embodiments, the removable storage device 130 is removable while the computing system is power on without adversely affecting the removable storage device 130 and the computing system. The removable storage device 130, in one or more embodiments, may be written to by the computing system(s) to which it is connected. Examples of removable storage devices 130 include, but are not limited to, universal serial bus (USB) devices, flash memory cards, hard drives, portable hard drives, compact discs, digital video discs, and/or the like.

Removable storage devices 130 present a security concern for air-gapped networks 102 since they can potentially contain malicious software and/or be used to steal data from the network 102. Conventional mechanisms for addressing security concerns of removable storage devices typically utilize whitelisting technologies that provide a list of removable storage devices that are allowed to be utilized with various systems. However, these whitelisting technologies typically require these systems to be connected to a central management server which defeats the purpose of air-gapped networks. In addition, these conventional security mechanisms usually cannot prevent a user from adding malicious software to the device after it has been authorized to access the air-gapped network and generally do not provide any mechanisms for auditing files copied to and from a removable storage device.

Embodiments of the present invention overcome these security issues by utilizing a tokenization and validation process. As will be discussed in greater detail below, a removable storage device 130 is first required to be authorized for use within an air-gapped network 102. As part of the authorization process, an authorization a token is generated that comprises a hash of the device contents, device identifying information, and optional access policy data. The contents of the authorization token ensure that any modification to the device contents or copying of the token to an unauthorized device is detectable by security modules of within the air-gapped network 102. In addition, these security modules may be configured to generate their own audit token that is stored on the removable storage device 130. The audit token may include an identifier of the air-gapped system 106 that the device 130 was coupled to and an audit file and/or hash. The audit token provides, for example, an auditable history of the air-gapped systems the removable storage device 130 interacted with. The audit file and/or hash may be used by one or more systems to ensure that files/data have not been copied to the device 130 and removed from the air-gapped network 102. In at least some embodiments, the audit tokens generated by the security modules may be appended to a local blockchain stored on the removable storage device 130.

For example, one or more information processing systems 114 disposed within the first network 102 and/or second network 104 comprise an authorization manager 132. A removable storage device 130, in one embodiment, is required to first connect with or be inserted into the authorization system 114 to have validation data 134 stored thereon and to be considered an authorized device. The authorization system 114 may be a standalone computing system (i.e., not connected to any other systems) or a networked computing system. After the removable storage device 130 has been authorized it may be connected to (or inserted into) a computing system 106, 108 within the air-gapped network 102. In one embodiment, each of the computing systems 106, 108 that are capable of accepting or communicating with a removable storage device 130 comprises a security manager 136, 138. The security manager 136, 138 utilizes the validation data/token 134 stored on the removable storage device 130 to validate that device 130 is authorized for use within the air-gapped network 102. If the security manager 136, 138 determines the removable storage device 130 is not authorized it is denied access to network 102 including the system 106, 108 it has been connected to. In addition, the security manager 136, 138 further blocks user access to the removable storage device 130 through the system 106, 108.

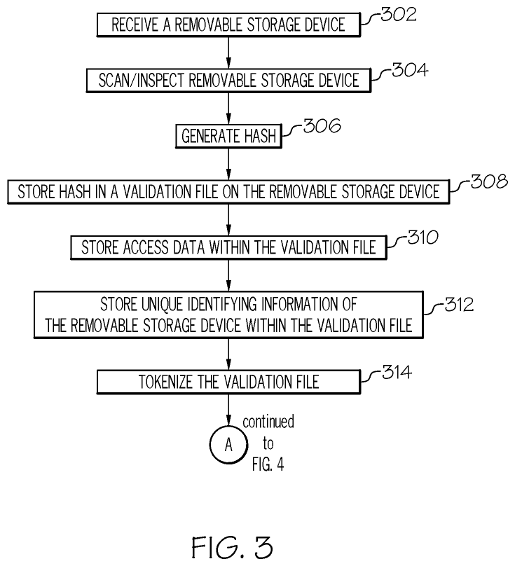

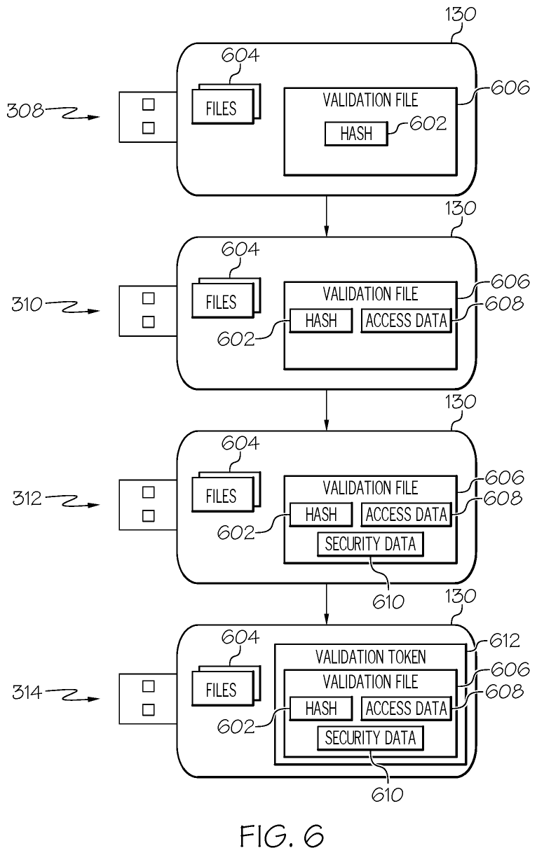

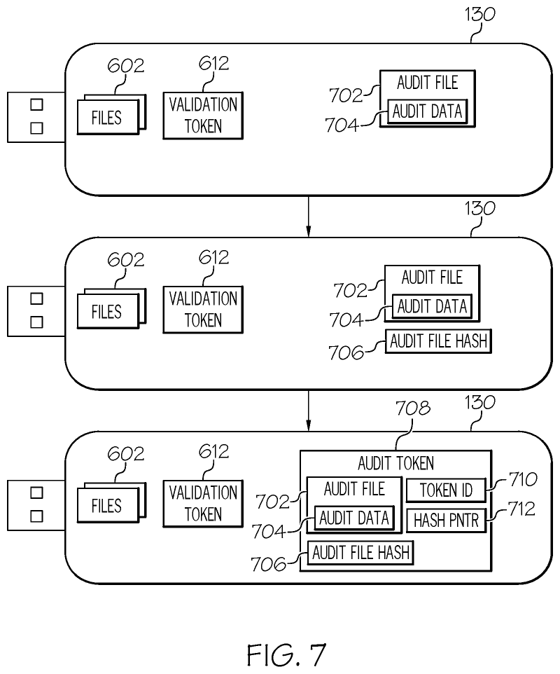

FIGS. 3 to 5 are operational flow diagrams illustrating one example of a process for authorizing and validating and storage devices 130 for use within the air-gap network 102. FIGS. 6 and 7 are illustrative examples of various steps in the operational flow diagrams of FIGS. 3-5. It should be noted that embodiments of the present invention are not limited to the sequence of the operations shown in FIGS. 3 to 5. For example, one or more of the operations may be performed at different point in the flow that what is shown in the FIGS. 3-5.

Starting at step 302, the authorization system 114 receives a removable storage device 130. The authorization system 114 may be located anywhere within the operating environment 100. In one example, the authorization system 114 may be located at a security counter at which the user carrying the removable storage device 130 is required to check in at before accessing the air-gapped network 102. The authorization manager 132, at step 304, optionally scans/inspects the removable storage device 130 for any viruses, malware, or other malicious software and files. If the removable storage device 130 comprises malicious software/files the authorization process can be stopped and the removable storage device is not authorized. Since the removable storage device 130 is not authorized it will not be granted access to any system 106, 108 or component 120 to 124 within the air-gapped network 102. It should be noted that additional operations may also be performed such as (but not limited to) generating notifications to one or more users and/or systems that a malicious removable storage device has been detected; recording an indication that the device 130 contained malicious software/files along with date, time, and device identification data; and/or the like.

After the optional scan has been performed, the authorization manager 132 generates a hash 602 (FIG. 6) for the removable storage device 130 at step 306. In one embodiment, the hash 602 is generated by applying a hashing function to the contents such as (but not limited to) one or more files 604 stored on the removable storage device 130. The hashing operation maps data of an arbitrary size (e.g., the files 604 stored on the device 130) to a bit string of a fixed size using a mathematical function.

The authorization manager 132 may use various hashing functions/algorithms to generate the hash 602 such as, but not limited to, keyed or un-keyed cryptographic hash functions (e.g., MD5, MD6, SHA-256, SHA-512, etc.), non-cryptographic hash functions, universal hash functions, and/or the like. In some embodiments, a single hash 602 is generated for the combination of the two or more files 604 while in other embodiments a separate hash 602 is generated for each of the one or more files. It should be noted that, in some embodiments, the authorization manager 132 may generate one or more scan result files indicating that the removable storage device 130 is free of malicious software/files. In these embodiments, the hash 602 may be generated based on the original contents of the device 130 and the scan result file(s). However, in other embodiments, the hash 602 is not generated based on the scan result file(s).

In some instances the removable storage device 130 may not comprise any files. In these instances a null hash may be generated. However, in some embodiments, the authorization manager 132 may generate one or more files comprising random data and store these files on the removable storage device 130. In this embodiment, the authorization manager 132 generates the hash 602 using the one or more generated files that have been stored on the removable storage device 130.

After the hash 602 has been generated, the authorization manager 132 stores the hash (or hashes) 602 in a validation file 606 on the removable storage device 130 at step 308. In one embodiment, the authorization manager 132, at step 310, also stores access data 608 in addition to the hash 602 within the validation file 606. Examples of access data 608 include (but are not limited to) authorization/access expiration data; access clearance data; identification of specific systems 106, 108 and components 120 to 124, specific files, specific storage volumes, and/or the like that the device 130 is granted/restricted access; a timestamp generated by the authorization manager 132; and/or the like. The authorization/access expiration data indicates a specific data/time or a given number or minutes, hours, etc. that the device 130 is granted access to the air-gapped network 102. The access clearance data may include an identification of specific systems 106, 108 and components 120 to 124, specific files, specific storage volumes, and/or the like within the air-gapped network 102 that are granted/restricted access through the use of the device 130. In at least some embodiments, the access data 608 comprises different sets of access data for different systems 106, 108 and/or components 120 to 124 within the air-gapped network 102. Each different set of access data 608 may be associated with a unique identifier of its corresponding system/component or any other identification mechanism.

In one embodiment, the authorization manager 132 salts the validation file 606 with security data 610 associated with the removable storage device 130 at step 312. For example, in one embodiment, the authorization manager 132 obtains device attribute data such as the make, model, and/or serial number of the removable storage device 130 from a storage area of the device 130. The device attribute data is then stored in the validation file 606 as security data 610 along with the hash 602 and access data 608. It should be noted that, in some embodiments, the hash 602 may not be generated until after one or more of access data 608 and security data 610 have been added to the validation file 606.

The authorization manager 132 then tokenizes the validation file 606 at step 314. Various encryption mechanisms may be used to tokenize the validation file 606. For example, symmetric key encryption, public key (asymmetric) encryption, and/or the like may be used. In one example, the authorization manager 132 utilizes asymmetric encryption where mathematically related public and private keys are used for encryption and decryption. In this example, the authorization manager 132 obtains the public key for each system 106, 108 (and/or component 120 to 124) within the air-gapped network 102 that may accept a removable storage device 130. If multiple systems 106, 108 exist within the air-gapped network 102 each of the systems may have a separate public-private key pair. However, in other embodiments, a single public-private key pair may be used for all of the systems 106, 108 within the air-gapped network 102.

The public key(s) obtained by the authorization manager 132 may be stored locally on the authorization system 114, stored on a remote system, and/or the like. For example, an off-line key exchange may be performed using a trusted device upon initial configuration of the authorization manager 132 and security manager 136 where the public key or keys of the air-gapped systems 106, 108 are stored on the authorization system 114 and the public key of the authorization system 114 is stored on the air-gapped systems 106, 108. A similar process may be performed to store a private key on the air-gapped systems 106, 108.

The authorization manager 132 utilizes the public key of an air-gapped system 106, 108 and one or more encryption algorithms to encrypt the validation file 606. The result of the encryption process is an encoded validation file 606 (herein referred to as a “validation token 612”) that may only be decoded/decrypted using the related private key stored on the system(s) 106, 108 for which the removable storage device 130 has been authorized. Once the validation token 612 has been created, the removable storage device 130 is considered to be an authorized device. In another embodiment, instead of encrypting the hash 602, access data 608, and security data 610 the authorization manager 132 utilizes a digital signature process to generate the validation token 612. For example, the authorization manager 132 generates another hash for the access data 608 and security data 610. Then, the authorization manager 132 digitally signs the contents hash 602 and the additional hash using its private key. The digitally signed hashes may be referred to as the validation token 612 in this embodiment. A security manager 136, 138 within the air-gapped system 106, 108 is able to verify that a trusted authentication manager 132 generated the validation token 612 based on the token 612 being able to be decrypted using the public key of the authorization manager 132.

It should be noted that the validation token 612 is not limited to the configuration shown in FIG. 6 as one or more additional components may be added to the audit validation token 612 and/or one or more of the components may be removed from the validation token 612. In addition, one or more of the components may be stored on the removable storage device 130 outside of the validation token 612.

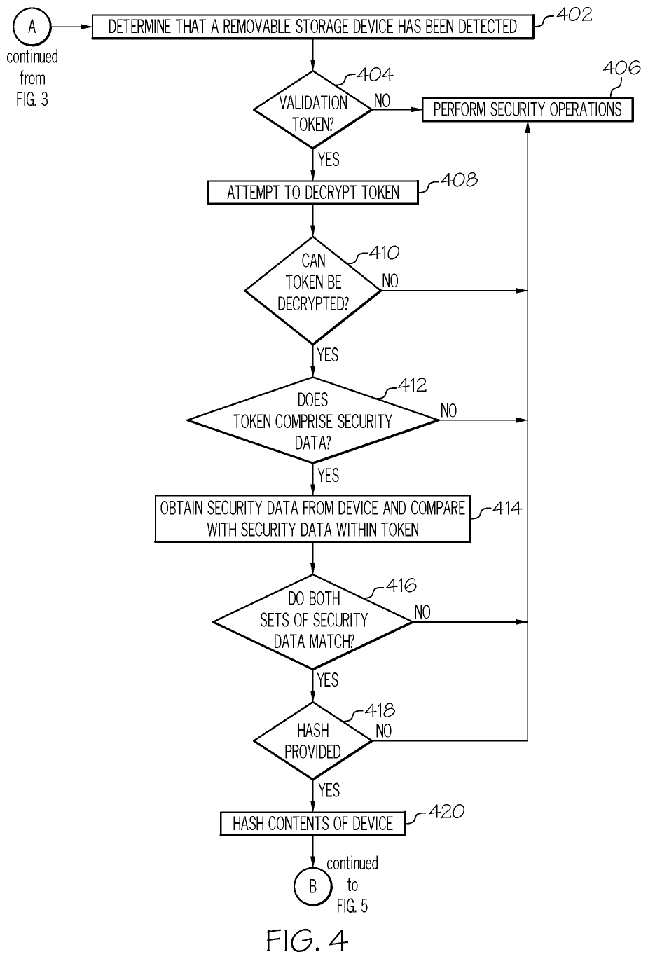

Referring now to FIG. 4, a user connects (or inserts) the removable storage device 130 into an air-gapped system 106 and the security manager 136 of the system 106, at step 402, detects a removable storage device 130. The security manager 136, at step 404, inspects the removable storage device 130 to determine if a validation token 612 is stored on the device 130. If the security manager 136 determines that a validation token 612 is not stored on the device 130, the device 130 is not validated and the security manager 136 determines the device 130 to be an unauthorized device. The security manager 136 then performs one or more security actions/operations at step 406.

One example of a security operation is blocking the user from having access to the removable storage device 130 through the system 106. In other words, the device 130 is not mounted and cannot be interacted with through the system 106. In another example, the security manager 136 blocks the removable storage device 130 from having access to the system 106. For example, the security manager 136 denies the device 130 access to a file system managed by the system 106. In another example, the security manager 136 may also deny the user of the device 130 access to the system 106 as well. For example, the removable storage device 130 may be used as an authorization device that allows a user to log into the system 106 upon successful verification/authorization of the device 130. If the validation token 612 is not detected, the security manager 136 may instruct the air-gapped system 106 to not display the login screen to the user or any other components that would allow the user to interact with the system 106. In addition, a notification or alert may be transmitted to one or more users or systems indicating that an unauthorized removable storage device has been connected to the system 106.

If the security manager 136 determines that a validation token 612 is stored on the removable storage device 130, the security manager 136 tries to decrypt the token with its private key at step 408. If the security manager 136, at step 410, determines that it is unable to decrypt the validation token 612 the removable storage device 130 is not validated and determined to be unauthorized. The process flows to step 406 where the security manager 136 performs one or more security operations. However, if the security manager 136 is able to decrypt the validation token 612 using its private key then the security manager 136, at step 412, determines if the token 612 comprises security data 610.

If the security data 610 was not included within the token 612 the removable storage device 130 is not validated and determined to be an unauthorized device. The process flows to step 406 where the security manager 136 blocks access to the system 106. It should be noted that, in another embodiment, after the validation token 612 has been decrypted the security manager 136 can inspect the validation token 612 to determine whether the token 612 conforms to an expected format. For example, the security manager 136 determines if the token 612 comprises the hash 602, the access data 608, and the security data 610 used to salt the validation file 606. If the validation token 612 fails to comprise the expected contents/data then the security manager 136 determines that the device 130 is an unauthorized device and the process flows to step 406 where one or more security operations are performed.

If the validation token 612 does comprise security data 610 the security manager 136 obtains corresponding security data from the removable storage device 130 and compares the two sets of security data at step 414. If the security manager 136, at step 416, determines that the two sets of security data do not match the removable storage device 130 is not validated and determined to be an unauthorized device. For example, the security manager 136 determines the removable storage device currently connected to the system 106 is not the same device for which the token 612 was generated (i.e., the token 612 was copied to the current device 130). The process then flows to step 406 where the security manager 136 blocks access to the system 106.

If the two sets of security data do match, the security manager 136 determines if the content hash 602 was provided in the token 612 at step 418. If the content hash 602 was not provided in the token 612 the removable storage device 130 is not validated and is determined to be an unauthorized device. The process flows to step 406 of FIG. 4 where the security manager 136 blocks access to the system 106. If the content hash 602 was provided, the security manager 136 performs one or more hashing operations on the files at step 420 similar to that discussed above with respect to the authorization manager 132. The authorization manager 132 and the security manager 136, in one embodiment, are configured to utilize the same hashing functions/algorithms. It should be noted a null hash can be generated by the security manager 136 if the removable storage device 130 does not comprise any files.

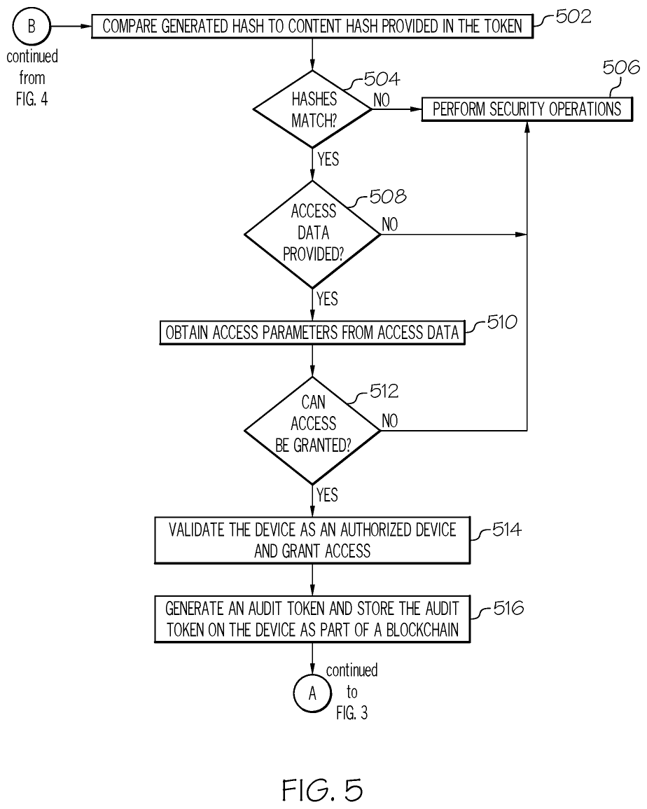

The process flow continues to FIG. 5 where the security manager 136 compares its generated hash to the content hash 602 provided in the token 612 at step 502. If the security manager 136, at step 504, determines that the two hashes do not match then the current state of the files on the removable storage device 130 is not the same as it was upon authorization by the authorization manager 132. For example, one or more files have been added, deleted, and/or modified. Accordingly, the removable storage device 130 is not validated and is determined to be an unauthorized device. The process flows to step 506 where the security manager 136 performs one or more security operations/actions (e.g., blocks access to the system 106) similar to those discussed above with respect to step 406 of FIG. 4.

If the hashes match then the security manager 136 determines whether the token 612 includes access data 608 at step 508. As discussed above, the access data 608 indicates who may or more not access the air-gapped network 102, the systems and components that may or may not be accessed, the times/dates at which the systems and components may or may not be accessed, an expiration time for granted access, and/or the like. If access data 608 is not included within the token 612, the removable storage device 130 is not validated and the process flows to step 506 where the security manager 136 blocks access to the air-gapped network 102 and security operations are performed.

However, in another embodiment, the security manager 136 validates the removable storage device 130 as an authorized device and grants access to the system 106 even though access data 608 was not included within the token 612. In this embodiment, the security manager 136 may grant access to the air-gapped system 106 (and possible other portions of the network 102) without implementing an access policy or rule. In another embodiment, the security manager 136 grants access to the system 106 using a default access policy when access data 608 is not included within token 612. The default access policy, in one embodiment, may include default parameters for access policy/rule such as an expiration time for granted access, user authorization/restriction, system and component authorization/restriction, time and date authorization/restriction, and/or the like.

If access data 608 is included within the token 612, security manager 136 obtains access parameters from the access data 608 at step 510. As discussed above, examples of access data parameters include (but are not limited to) authorization/access expiration data; access clearance data; identification of specific systems 106, 108 and components 120 to 124, specific files, specific storage volumes, and/or the like that the device 130 is granted/restricted access; a timestamp generated by the authorization manager 132; and/or the like. In some embodiments, there may be different access data 608 for different systems/components within the air-gapped network 102. In these embodiments, the security manager 136 identifies the access data 608 for its corresponding system 106 based on a unique identifier of the system 106 and/or any other identification mechanism.

The security manager 136, at step 512, utilizes the access data parameters to determine if access to the air-gapped system 106 can be granted at this time. If access cannot be granted, the process flows to step 506 where one or more security operations are parameter. However, if access can be granted the security manager 136, at step 514, validates the removable storage device 130 as an authorized device and grants access to at least the air-gapped system 106 that it is coupled to.

For example, consider an example where the access data 608 included a time stamp generated by the authorization manager 132 and an authorization expiration time of 3 hours. In this example, the security manager 136 determines whether 3 hours have passed since the time indicated by time stamp. The security manager 136 can make this determination by checking its own system clock, which may be synched with the system clock of the authorization system 114. If 3 hours have passed, the security manager 136 determines that the authorization granted to the removable storage device 130 by the authorization manager 132 has expired. Therefore, the security manager 136 is not validated and the process flows to step 506 where one or more security actions are taken (e.g., the device 130 is blocked from having access to the air-gapped network 102).

However, if the authorization has not expired the security manager 136 validates the removable storage device 130 as an authorized device and grants the device 130 access to the air-gapped system 106 for its remaining authorization time. For example, the removable storage device 130 may mount to the file system being managed by the air-gapped system 106; execute one or more applications on the air-gapped system 106, and/or the like. In one embodiment, once the remaining authorization time has expired the security manager 136 blocks access to the air-gapped system 106 and network 102.

It should be noted that instead of performing illustrated sequence of steps 412 to 420 in FIGS. 4 and 502 to 512 in FIG. 5, the security manager 136 (after step 410 of FIG. 4) is able to first determine whether the decrypted validation token 612 comprises all of the expected contents such as the security data 610, the content hash 602, access data 608, etc. If one or more of these expected datasets are not included within the decrypted validation token 612 the process flows to step 406 where one or more security operations are performed. However, if the expected datasets are included within the decrypted validation token 612 then the security manager 136 continues one with evaluating each of these datasets as discussed above (e.g., compare security data, compare hashes, evaluate access data, etc.).

In addition to the above, the security manager 136, in one embodiment, generates an audit token and stores the audit token on the removable storage device 130 at step 516. For example, the security manager 136 generates an audit file 702 (FIG. 7) comprising audit data 704. The audit data 704, in one embodiment, comprises identification information for the air-gapped system 106 that allows the system 106 to be distinguished from other systems 108 in the network 102. Additional information such as date/time information at which the removable device 130 was coupled to the system 106 may also be part of the audit data 704. In one embodiment, the security manager 136 monitors the various actions the user and/or removable storage device 130 performs while interacting with the air-gapped system 106. In this embodiment, data identifying such actions and optional details of the actions are also stored within as part of the audit data 704. For example, data such as file names or identifiers of the files accessed, modified, added, and/or deleted may be included as part of the audit data 704 as well.

The security manager 136 performs one or more hashing operations on the audit file 702 (similar to those discussed above with respect to step 510 of FIG. 3) to generate an audit file hash 706. The audit file hash 706 is stored on the removable storage device 130. The audit file hash 706 allows a computing system that is performing an audit of the removable storage device's activities to determine whether the audit file 704 has been altered.

A tokenization process is performed (similar to those discussed above with respect to step 318 of FIG. 3) on the audit file 702 to generate an audit token 708. For example, the audit file 702 is encrypted utilizing one or more encryption mechanisms. For example, symmetric key encryption, public key (asymmetric) encryption, and/or the like may be used. In one example, the security manager 136 utilizes asymmetric encryption where mathematically related public and private keys are used for encryption and decryption. In this example, the security manager 136 obtains the public key for whatever system will perform audit operations such as the authorization system 114. The public key may be stored locally on the air-gapped system or on another system within the air-gapped network 102. The result of the encryption process is an encoded audit file 702 referred to as the “audit token 708”.

In another embodiment, instead of encrypting the audit file 702, audit data 704, and audit file hash 706 to form the audit token 708 one or more of these components may be digitally signed to form the token 708 similar to the process discussed above with respect to the validation token 612. The authorization manager 132 is able to verify that a trusted system 106, 108 within the network 102 generated the audit token 708 based on the token 708 being able to be decrypted using the public key of the system 106, 108. It should be noted that the audit token 708 is not limited to the configuration shown in FIG. 7 as one or more additional components may be added to the audit token 708 and/or one or more of the components may be removed from the audit token 708. In addition, one or more of the components may be stored on the removable storage device 130 outside of the audit token 708.

In at least some embodiments, each system 106, 108 that the removable storage device 130 is connected to generates and stores an audit token 708. If the removable storage device 130 connects to an air-gapped system 106, 108 multiple times separate tokens can be generated for each connection instance or an initial token can be generated and then updated for each subsequent connection instance. The audit tokens 708 are used by a computing system 114 to perform an audit of, for example, the systems 106, 108 the device 130 was connected to, the operations performed thereon by the user/device, if any files are being taken from the air-gapped network 102, and/or the like.

For example, the user may be required to connect the removable storage device 130 to the authorization system 114 upon exiting the air-gapped network 102. The authorization manager 132 obtains the audit token 708 and any other audit data 704 stored on the device 130. The token 708 and any additional audit data 704 is then stored on the authorization system 114 or another system, and is removed from the removable storage device 130 prior to the device 130 being returned to the user. The authorization manager 132 (or another system) utilizes the audit token 708 (and any addition audit data) to perform auditing operations. For example, for each audit token 708 stored on the device 130) the authorization manager 132 decrypts the token 708 utilizing the public key of the air-gapped system 106, 108 that generated the audit token 708. If an audit file hash 706 was included within the token 708 the authorization manager 132 performs a hashing operation on the audit file 702 and compares its generated hash to the audit file hash 706 included within the token 708 to ensure the audit file 702 was not tampered with. The authorization manager 132 then analyzes the audit data 704 to determine and record the system(s) that the removable storage device 130 was connected to, the identification of files that were accessed, any modifications made to files, and/or the like.

In one or more embodiments, the audit token 708 is stored on the removable storage device 130 as part of an immutable ledger such as a blockchain. This provides an immutable audit trail that can be trusted. For example, consider a first audit token that is stored on the removable storage device 130 by the security manager 136. In addition to the audit file 702 and audit file hash 706, the first audit token also comprises an identifier 710 of the authorization token 612 (i.e., the base block) and a hash pointer 712, which comprises a hash of the data inside the authorization token 612. When a subsequent audit token is generated and stored on the removable storage device 130 it is stored with an identifier of the most recent audit token in the list/chain and a hash of the data inside the most recent audit token. For example, a second audit token is stored on the device 130 with an identifier of the first audit token and a hash of the data inside the first audit token.

Accordingly, in at least some embodiments, the audit file 702 including the audit data 704, the audit file hash 706, the token identifier 710, and the hash point 712 are encrypted to form the audit token 708. However, one or more of these components may be kept separate from the audit token 708. The configuration of the tokens 612, 708 as an immutable ledger such as a blockchain ensures that the data contained therein can be trusted as being accurate, reliable, and tamper-free. For example, prior to or during the audit operations discussed above the authorization manager 132 may analyze the token ID 710 and hash pointer 712 obtained from the audit token 708. If the token ID 710 and/or hash pointer 712 do not match the data in their corresponding audit token then the authorization manager 132 determines that the data within audit tokens 708 has been compromised and cannot be trusted.

Although the above embodiments utilized an air-gapped network and air-gapped systems as one example of the type of network and computing systems applicable to the present invention it should be noted that other types of networks and computing systems are applicable as well. For example, embodiments of the present invention may also be implemented in non-air-gapped networks and systems. In these embodiments, the network 102 is connected to one or more outside networks and/or unsecure networks 104 and its computing systems 106, 108 are reachable from outside the network 102. In another example, embodiments of the present invention may also be implemented within one or more standalone computing systems, which are systems that are not connected to any other system or component. In other words, any type of computing system capable of receiving removable storage devices may implement the security manager 136 for validating the removable storage devices and protecting the computing system from unauthorized removable storage devices.

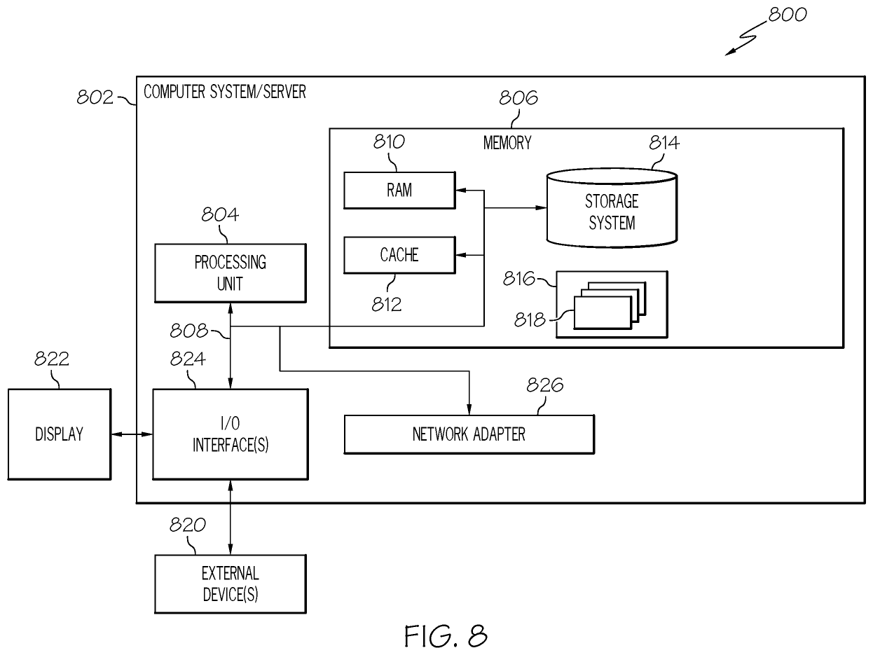

Referring now to FIG. 8, this figure is a block diagram illustrating an information processing system that can be utilized in embodiments of the present invention. The information processing system 802 is based upon a suitably configured processing system configured to implement one or more embodiments of the present invention such as air-gapped systems 106, 108 and/or authorization system 114 of FIG. 1. The components of the information processing system 802 can include, but are not limited to, one or more processors or processing units 804, a system memory 806, and a bus 808, which couples various system components including the system memory 806 to the processor 804. The bus 808 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

The system memory 806 may include computer system readable media in the form of volatile memory, such as random access memory (RAM) 810 and/or cache memory 812. The information processing system 802 can further include other removable/non-removable, volatile/non-volatile computer system storage media. By way of example only, a storage system 814 can be provided for reading from and writing to a non-removable or removable, non-volatile media such as one or more solid state disks and/or magnetic media (typically called a “hard drive”). A magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to the bus 808 by one or more data media interfaces. The memory 806 can include at least one program product having a set of program modules that are configured to carry out the functions of an embodiment of the present invention.

Program/utility 816, having a set of program modules 818, may be stored in memory 806 by way of example, and not limitation, as well as an operating system, one or more application programs, other program modules, and program data. Each of the operating system, one or more application programs, other program modules, and program data or some combination thereof, may include an implementation of a networking environment. Program modules 818 generally carry out the functions and/or methodologies of embodiments of the present invention.

The information processing system 802 can also communicate with one or more external devices 820 such as a keyboard, a pointing device, a display 822, etc.; one or more devices that enable a user to interact with the information processing system 802; and/or any devices (e.g., network card, modem, etc.) that enable computer system/server 802 to communicate with one or more other computing devices. Such communication can occur via I/O interfaces 824. Still yet, the information processing system 802 can communicate with one or more networks such as a local area network (LAN), a general wide area network (WAN), and/or a public network (e.g., the Internet) via network adapter 826. As depicted, the network adapter 826 communicates with the other components of information processing system 802 via the bus 808. Other hardware and/or software components can also be used in conjunction with the information processing system 802. Examples include, but are not limited to: microcode, device drivers, redundant processing units, external disk drive arrays, RAID systems, tape drives, and data archival storage systems.

As will be appreciated by one skilled in the art, aspects of the present invention may be embodied as a system, method, or computer program product. Accordingly, one or more aspects of the present invention may take the form of an entirely hardware embodiment, an entirely software embodiment (including firmware, resident software, micro-code, etc.) or an embodiment combining software and hardware aspects that may all generally be referred to herein as a “circuit”, “module”, or “system”. Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service

Provider).

Aspects of the present invention have been discussed above with reference to flowchart illustrations and/or block diagrams of methods, apparatus (systems) and computer program products according to various embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method, on an information processing system, comprising:
detecting a removable storage device;
determining if a validation token is stored on the removable storage device;
obtaining a first content hash and a first set of device verification data from the validation token based on the validation token being stored on the removable storage device;
obtaining a second content hash based on hashing content currently stored on the removable storage device;
obtaining a second set of device verification data from the device verification data;
denying the removable storage device access to the information processing system based on at least one of the first and second content hashes failing to match and the first and second sets of device verification data failing to match; and
granting the removable storage device access to the information processing system based on the first and second content hashes matching and the first and second sets of device verification data matching.

2. The method of claim 1, further comprising:
denying the removable storage device access to the information processing system based on determining that the validation token is not stored on the removable storage device.

3. The method of claim 1, wherein obtaining the first content hash and a first set of device verification data comprises decrypting the validation token.

4. The method of claim 3, wherein the validation token is decrypted using a private encryption key of the information processing system.

5. The method of claim 1, wherein granting the removable storage device access to the information processing system further comprises:
determining that the validation token comprises access data;
determining, from the access data, a time value indicating when an authorization of the removable storage device for accessing the information processing system expires; and
determining that the authorization of the removable storage device has not expired.

6. The method of claim 5, wherein determining that the authorization of the removable storage device has not expired comprises:
comparing the time value to a system clock of the information processing system.

7. The method of claim 1, wherein denying the removable storage device access to the information processing system further comprises:
determining that the validation token comprises access data;
determining, from the access data, a time value indicating when an authorization of the removable storage device for accessing the information processing system expires; and
determining that the authorization of the removable storage device has expired.

8. The method of claim 1, further comprising:
generating, based on detecting the removable storage device, an audit token comprising at least an identifier of the information processing system; and
storing the audit token on the removable storage device.

9. The method of claim 8, wherein the audit token further comprises:
a token identifier of a most recent token stored on the removable storage device; and
a hash pointer comprising a hash of data within the most recent token.

10. The method of claim 9, wherein storing the audit token comprises:
storing the audit token in a blockchain configuration with at least the validation token on the removable storage device.

11. A method, on a computing device, for authorizing a removable storage device for use on one or more information processing systems, the method comprising:
identifying a set of files on a removable storage device;
hashing the set of files to create a set of hashing data;
storing the set of hashing data within a validation file on the removable storage device;
storing device verification data associated with the removable storage device in the validation file; and
tokenizing the validation file to generate a token that is stored on the removable storage device.

12. The method of claim 11, further comprising:
obtaining the device verification data directly from the removable storage device.

13. The method of claim 12, wherein the device verification data comprises at least a unique identifier of the removable storage device.

14. The method of claim 11, wherein tokenizing the validation file comprises:
encrypting the validation file using a public key associated with at least one computing system for which the removable storage device is being authorized to access.

15. The method of claim 11, wherein identifying the set of files on the removable storage device comprises:
determining that the removable storage device fails to comprise at set of files; and
generating the set of files utilizing random data.

16. An information processing system comprising:
memory;
at least one processor; and
a security manager operatively coupled to the memory and the at least one processor, wherein the security manager:
detects a removable storage device;
determines if a validation token is stored on the removable storage device;
obtains a first content hash and a first set of device verification data from the validation token based on the validation token being stored on the removable storage device;
obtains a second content hash based on hashing content currently stored on the removable storage device;
obtains a second set of device verification data from the device verification data;
denies the removable storage device access to the information processing system based on at least one of the first and second content hashes failing to match and the first and second sets of device verification data failing to match; and
grants the removable storage device access to the information processing system based on the first and second content hashes matching and the first and second sets of device verification data matching.

17. The information processing system of claim 16, wherein the security manager grants the removable storage device access to the information processing system further based on:
determining that the validation token comprises access data;
determining, from the access data, a time value indicating when an authorization of the removable storage device for accessing the information processing system expires; and
determining that the authorization of the removable storage device has not expired.

18. The information processing system of claim 17, wherein determining that the authorization of the removable storage device has not expired comprises:
comparing the time value to a system clock of the information processing system.

19. The information processing system of claim 16, wherein the security manager denies the removable storage device access to the information processing system further based on:
determining that the validation token comprises access data;
determining, from the access data, a time value indicating when an authorization of the removable storage device for accessing the information processing system expires; and
determining that the authorization of the removable storage device has expired.

20. The information processing system of claim 16, wherein the security manager further:
generates, based on the removable storage device being detected, an audit token comprising at least:
an identifier of the information processing system,
a token identifier of a most recent token stored on the removable storage device, and
a hash pointer comprising a hash of data within the most recent token; and
stores the audit token on the removable storage device.
